(19) United States
(12) Patent Application Publication
(10) Pub. No.: US 2004/0065560 A1
(43) Pub. Date: Apr. 8, 2004

(54) Electroforming device for manufacturing fine metal tubular material

(75) Inventor: Akira Kenjo, Tokyo (JP)

Correspondence Address: BACON & THOMAS, PLLC, 625 SLATERS LANE, FOURTH FLOOR, ALEXANDRIA, VA, 22314

(73) Assignee: O'Link Technology L.L.C., Newark City, DE

(21) Appl. No.: 10/262,931

(22) Filed: Oct. 3, 2002

(51) Int. Cl. B23H 3/00

(52) U.S. Cl. 205/672

(57) ABSTRACT

This invention relates to the electroforming device for manufacturing fine metal tubular material in an effort to obtain a uniform thickness of metal deposit on the wire core, to promote high accuracy in the outer diameter and even roundness, and to produce high precision coaxial cylindrical very fine metal tubular material.

The electrolytic metal collection net in the electrolytic collection compartment is being applied with the positive current, wire core and negative current. The electrolytic metal precipitated in the electrolytic metal collection compartment (current flow) will float around the electrolytic metal collection compartment and being permitted to flow out through a fine opening. This electrolytic metal fluid will flow the opening and reaches a very narrow passage where the wire core is placed. Because of the long narrow passage, most electrolytic metal will attached on the wire core.

### FIELD OF THE INVENTION

This invention relates to the electroforming device for manufacturing fine metal tubular material with high roundness to fabricate the metal ring used as connectors between optic fibers and between optic fiber and light elements.

### BACKGROUND OF THE INVENTION

The metal ring is one of very critical parts in the optic communication. As shown in FIG. 8, the metal ring is about 10 mm long, having an outer diameter D about 1.25˜2.5 mm and the inner diameter d, corresponding to that of the optic fiber (outer diameter 0.125 mm), to be specified at 0.126 mm.

In the past, the zirconium is the major material to produce the metal ring. Since the production process is too complicated and the product quality is not high enough, so recently it is highly recommended to use the electroplating process to produce the metal ring.

Technically, it is feasible to borrow the [Method for Manufacturing Fine Flexible Hose] described in the Gazette Teh Kei Pin 11-193485 for manufacturing the metal tubular material.

FIG. 9 is the schematic diagram of electroforming facility section the Production Center has ever employed for the production of fine metal tubular material and FIG. 10 is a plane enlarged from FIG. 9, in which the electrolytic bath 1 is full with electrolyte 2, 3 is a power and 4 is positive connected to the power 3, which serves as the electrolytic metal collection net. 5 is the wire reel provided with several wire cores 6, 7 is a swivel shaft holding the wire reel 5, 8 is a drive motor driving the swivel shaft 7. The wire core 6 goes between the wire reel 5 and the swivel shaft 7. Power 3 will supply negative.

The wire reel 5 is disposed in the center of the electrolytic bath 1. The electrolytic metal connection net 4, in great number, are scattered at the inner periphery of the electrolytic bath 1. The lower part of both the electrolytic metal collection net 4 and the wire core 6 are immersed in the electrolyte 2 of the electrolytic bath 1.

After the power 3 is on, the electrolytic metal collection net 4 and the wire core 6 are energized, the wire reel 5 begins to rotate.

The traditional technique worked in such a manner when the surface of the wire core 6 has been deposited with enough thickness of electrolytic metal film, the wire core 6 was therefore removed to obtain a metal tube having the inner diameter similar to the outer diameter of the wire core 6. Then, by cutting the metal tube at the desired length, said metal tube will become the metal tubular material, as shown in FIG. 8.

The traditional technique was theoretically capable of producing metal tubular material, but in fact, it is impossible to produce the metal tubular material of the quality required to produce the metal rings. The setbacks of the traditional technique were that the electrolytic metal film was not uniformly even and the coaxial and cylindrical precision was not exactly in similar shape in the longitudinal direction. The product has never won favorable comments.

As shown in FIG. 10, (only a partial diagram, since all electrolytic metal collection net 4 and the wire core 6 are arranged in similar way) when the metal electrolytic collection net 4 is connected to the positive of the power 3 and the wire core 6 to the negative, the current goes in the direction as the arrow A indicates where the current will flow from the electrolytic metal collection net 4 to the surrounding of the wire core 6, in particular, the current will converge on the vicinity of the wire core 6, so the current is not evenly distributed. However, the current flow in the similar direction as does the precipitated electrolytic metal.

In order to have the wire core 6 receive an even film of electrolytic metal, an appropriate drive mechanism is installed to make the wire core 6 rotate along the axis as B indicates and the wire reel 5 rotates as C indicates. The electrolytic metal collection net 4 is therefore moved forward. This arrangement is the most important factor to have the wire core 6 receive an even electrolytic metal film deposited.

In the electroforming process, there occurs a common feature; that is, the electrolytic metal will flock on the protruding part of the object to be plated, if there is a pop on the surface of the wire core 6. It is the place that receives more electrolytic meal than other places. This is the reason why it is not easy to get a uniform film on the electroformed product.

For the general electroplating product, the uneven film of electrolytic film is not considered as a serious problem. But for the metal ring, the high quality in roundness and coaxial similarity and cylindricality are very critical. To solve the unevenness in the electrolytic film and to gain the high product yield rate are most significant.

The problem of unevenness of the outer diameter on the electroformed metal product has been noted in Gazette Teh Kei 2001-207286. The Gazette recommended to adopt the cylindrical type of the electrolytic metal collection net for colleting the electrolytic metal, unfortunately, the recommended solution failed to produce an even film on the product.

Viewing from the above statements, the primary object of this invention to remove the bottlenecks the past experience has even encountered and to have a uniform metal film on the wire core and the fine metal tubular material so produced possesses the precise outer diameter, real roundness and high quality in coaxial and cylindrical shape.

### SUMMARY OF THE INVENTION

To achieve the above mentioned object, the conductive wire core which is electrolytic material is hereby connected to the negative of the power and the electrolytic metal or the electrolytic metal collection net, connected to the positive of the power. The said electrolytic metal or the electrolytic metal collection net and the wire core are immersed in the electrolyte of the electrolytic bath. After the power in turned on, the wire core will rotate and receive the electroforming process. This is the basic electroforming device to produce a fine metal tubular material in tiny diameter from the electrolytic metal on the wire core. In the electrolytic bath, the electrolytic metal, or the electrolytic metal collection net and the wire core are arranged in parallel and opposite position, for simple explanation, one wire core is being placed near the electrolyte flow passage on the top of the electrolytic bath. This arrangement confines the wire core disposed in a very narrow passage. While in the electrolysis, the electrolyte as well as the current will flow toward (so does the precipitated electrolytic metal) the narrow passage and toward the wire core. Under this condition the wire core will face a converged even flow. Since the wire core revolves, the revolution of the wire core renders the electrolysis processed evenly along the longitudinal periphery to produce a more precise surface.

The electroforming device provided in the claim 2 is employed to produce the fine tubular material as described in the claim 1. in which the narrow passage for the wire core is built at the lower part of the electrolytic bath, so does the electrolytic metal or the electrolytic metal collection net and a electrolyte supply compartment is organized exclusively for the purpose to supply the electrolyte to the electrolytic metal and the passage. This is a unique feature in the electrolytic bath which leads to successful production of the product as claimed in the claim 1.

### BRIEF DESCRIPTION OF THE DRAWINGS

FIG. 1 is a front section of the electroforming device of the invention.

FIG. 2 is a section of A-A from FIG. 1.

FIG. 3 shows a side view of critical parts of the electrolytic bath of FIG. 1.

FIG. 4 shows a current flow (electrolytic metal flow) in the electrolytic metal collection compartment.

FIG. 5 shows a current flow along the electrolytic metal collection compartment and the passage.

FIG. 6 shows a modified electrolytic metal collection compartment employed in the electroforming device.

FIG. 7 shows a side view of the modified electrolytic collection compartment.

FIG. 8 is a section of the metal ring showing the dimension and shape.

FIG. 9 is a prior art of the electroforming device for producing the fine tubular material.

FIG. 10 is a plane of electroforming device from FIG. 9.

### DETAILED DESCRIPTION OF THE INVENTION

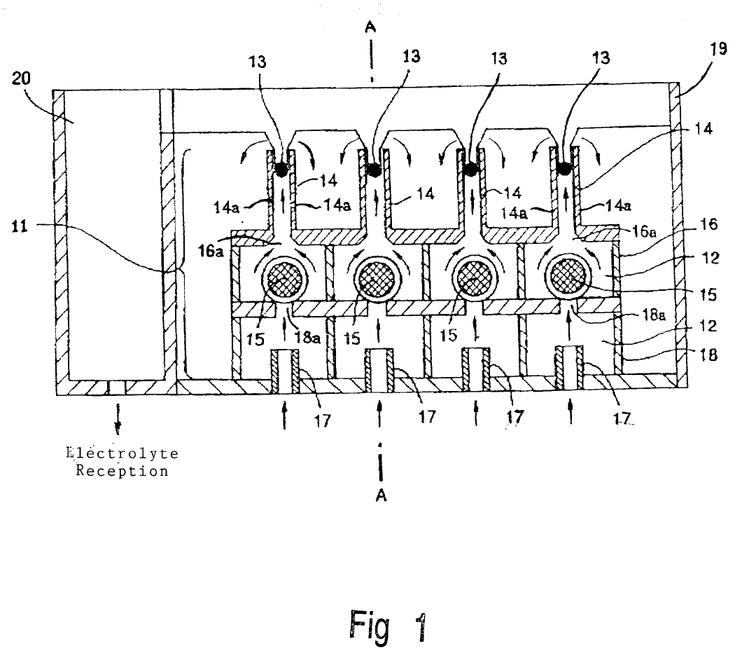

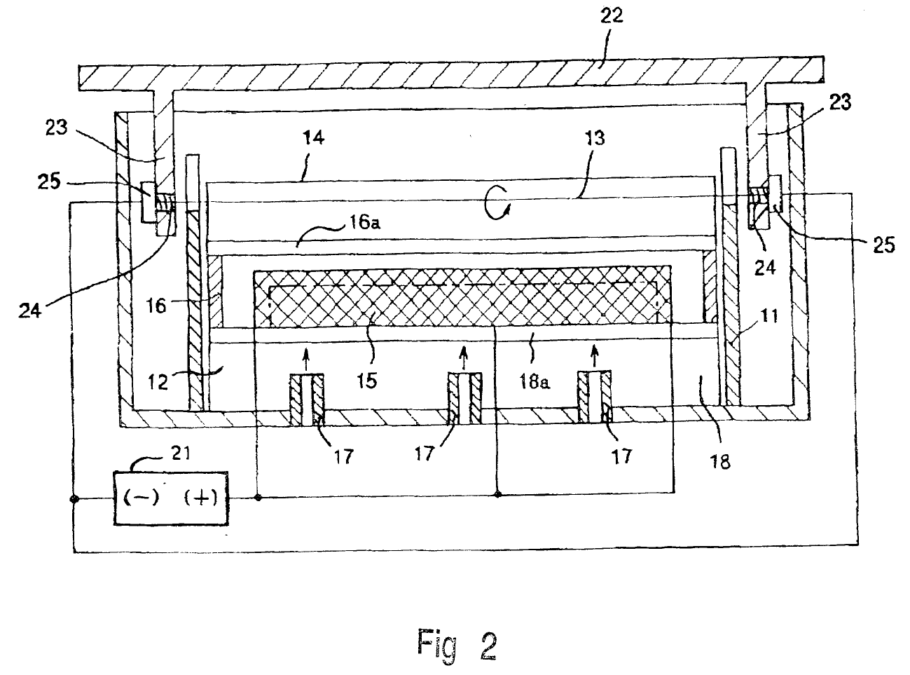

FIG. 1 is a front section of the electroforming device of the invention. FIG. 2 is the section of A-A from FIG. 1. FIG, 3 shows a side view of critical parts of the electrolytic bath of FIG. 1. The electrolytic bath 11 is full of the electrolyte 12. As shown in FIG. 1, the sample is a combination of four electrolytic baths 11.

There install a wire core 13 and a passage 14 in the lower part of and connected to the electrolytic bath 11, an electrolytic metal or electrolytic metal collection net 15 in the electrolytic metal collection compartment 16 both connected to the lower part of the electrolytic bath 11, and a supply portal 17 to supply the electrolyte 12 coming from electrolyte storage 18. The passage 14, the electrolytic metal collection compartment 16 and the electrolyte storage 18 shall be filly insulated with the polymer material which has strong resistance to the electrolyte 12.

The passage 14 is made of two panels 14a opposite disposed with open top to accept the wire core 13 and the electrolyte 12. The electrolytic metal collection compartment 16 is a box having a conic opening 16a. The supply portal 17 supplies new electrolyte 12.

The effluent of electrolyte 12 from each electrolytic bath 11 is collected and stored in the outer storage 19. As shown in FIG. 1, the electrolyte 12 will be recycled to the electrolyte recycling room 20.

In this experimentation, the wire core 13 used for electroforming process is of stainless steel wire, nonferrous wire, resin-made wire with no coat of electrolytic metal or the fiber wire. The electrolytic metal collection net 15 is made of titanium in cylinder or tetragon shape. The wire core 13 and the electrolytic metal collection net 15 are arranged in parallel in the same direction in the electrolytic bath 11.

As shown in FIG. 2, the positive of the power 21 is linked to two ends and the center of the electrolytic metal collection net 15 and the negative to two ends of the wire core 13. The reel 22 has two downward arms 23 to hold the wire core 13 in place. The downward arms 23 provide the loading mechanism for loading the wire core 13 and drive gear 25 for rotating the wire core 13.

The following is the detailed description of the electroforming procession.

The electrolyte 12 comes into the electrolytic bath 11 from the supply portal 17. The downward arms 23 of the reel 22 hold four wire core 13 and submerge them in the passage 14. When the power 21 is turned on, it makes a circuit from the electrolytic metal collection net 15 to the two ends of the wire core 13 which is driven to rotate by the drive gear 25.

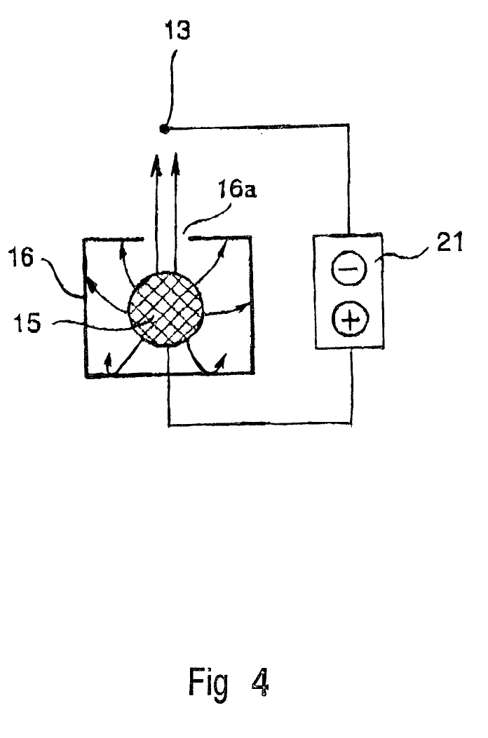

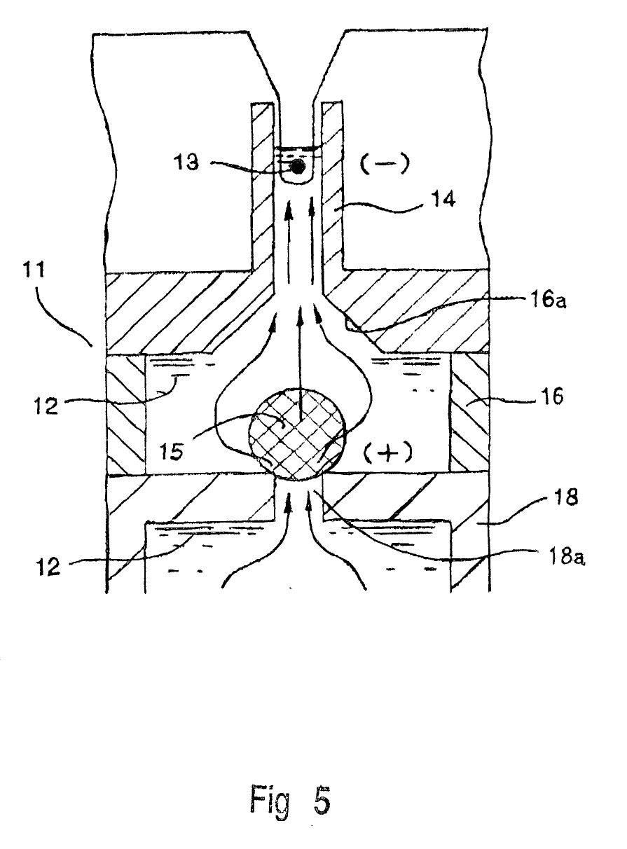

As shown in FIGS. 4 and 5, the electrolytic metal precipitated from the electrolytic metal collection net 15 will be led to the electrolytic metal collection compartment 16 and flows out of the conic opening 16a toward the wire core 13 and the passage 14 along with the electrolyte 12.

As shown in FIG. 4, the arrow in the electrolytic metal collection compartment 16 implies that the flow of the electrolytic metal is confined to the peripheral wall of the electrolytic metal collection compartment 16, and to be allowed out only through the conic opening 16a. As shown in FIG. 5, the electrolytic metal is permitted to flow toward to the narrow passage 14 and the wire core 13 therein, so the electrolytic metal therefore settles down on the surface of the wire core 13.

In this process of the electroforming operation, the charged electrolyte 11 comes out from the supply portal 17, flows through the passage 14 and returns to the recycling room 20 where after treated it will recirculate as new electrolyte.

In this process of the electroforming operation, the passage 14 is a narrow gap formed by two panels 14a. The applied current and voltage of the power 21 is properly regulated dependent on the diameter of the wire core 13 and the specified thickness of electrolytic metal film. It is regulated from time to time during the process of the electroforming until the desirable thickness of electrolytic metal film as well as roundness is obtained.

Obviously the concentration is focused on the wire core during the electroforming operation. Comparing with the prior art, this electroforming process will generate an even thickness of electrolytic metal film along the whole length of the wire core 13 with high precision (μm) in outer diameter.

By this electroforming process, after removal of the wire core 13, the metal ring material has high precise roundness and similar coaxial and cylindrical form with less than±1-3 μm tolerance.

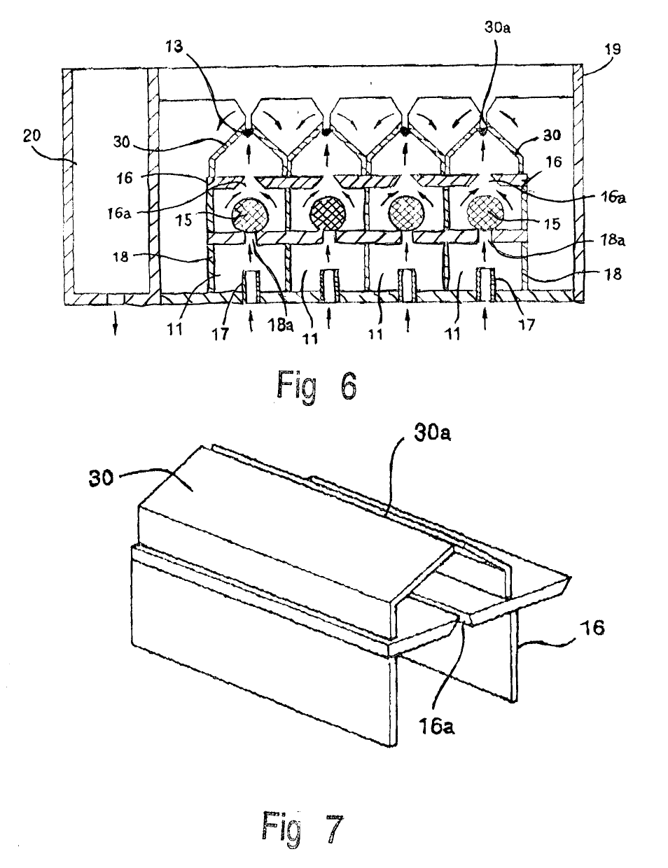

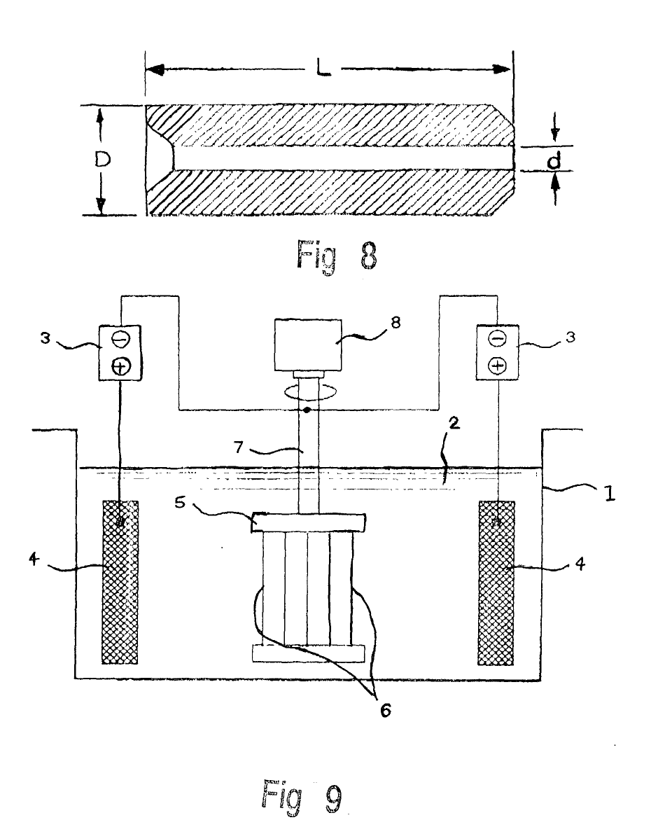

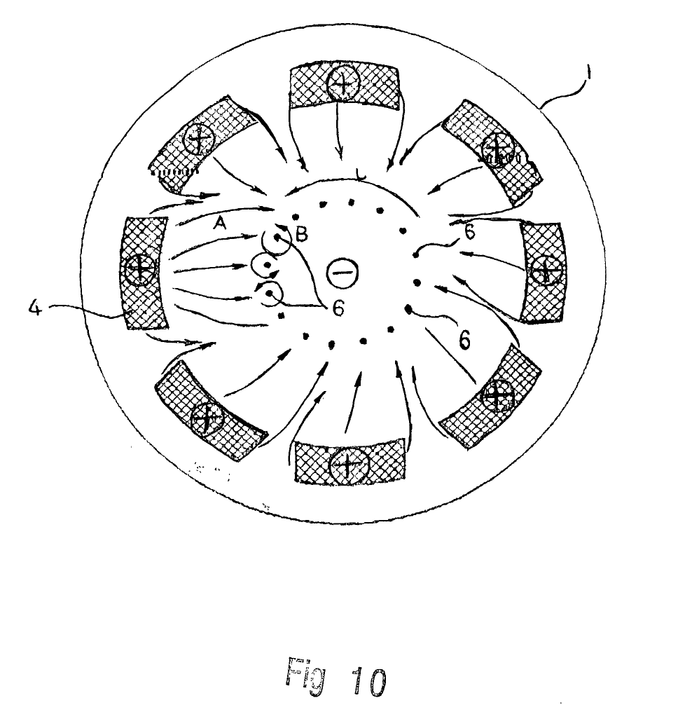

It is important to note that the passage 14 can be adequately modified in accordance with the size the purchase order asks for as shown in FIGS. 6 and 7.

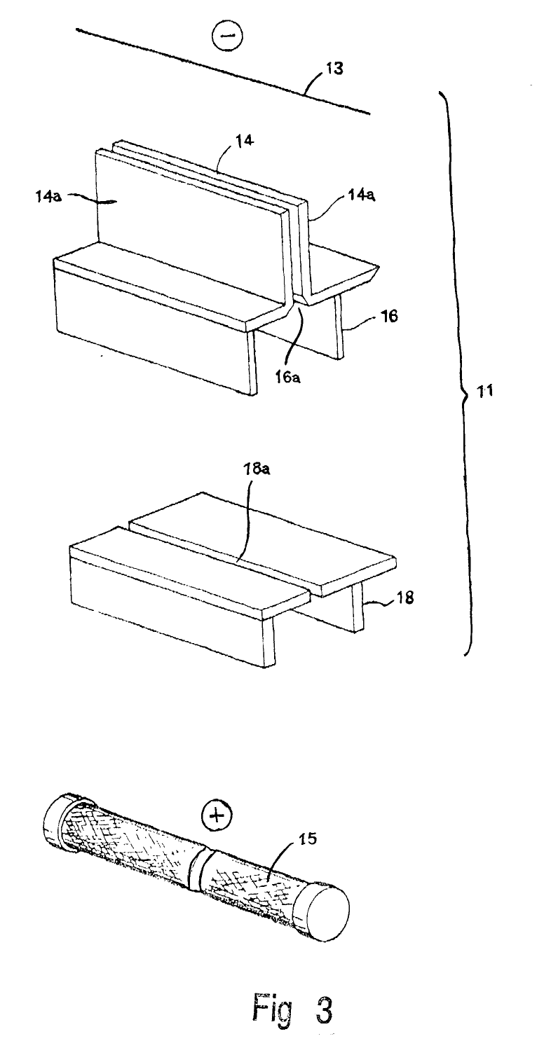

FIG. 6 shows the front section of the modified passage and FIG. 7 shows the side view of the modified passage. The electroforming device shown in the FIG. 6 is exactly similar to the device illustrated in FIGS. 1 through 5 even with same numbering.

As shown in FIGS. 6 and 7, the electrolytic metal collection compartment 16 is modified to have a tapered roof and an opening 30a in the passage 30. The wire core 13 is set in vicinity of the opening 30a. Comparing with the passage displayed in FIGS. 1 through 5, it improve greatly the thickness and the accuracy of outer diameter of the fine tubular material along the whole wire core 13.

As stated above, the electrolytic metal or the electrolytic metal collection net and the wire core are arranged in parallel in the same direction in the electrolytic bath. The wire core is placed on the top of the electrolytic bath and the electrolyte will flow through the passage. In the electroforming process, the electrolyte flow and the electrolytic metal flow are confined in the narrow passage, and finally flocked on the revolving wire core; it produces an even film with improved profile. After removal of the wire core, the tubular material present a high roundness, high coaxial and cylindrical shape, good enough as used as the metal ring material.

What is claimed is:

1. An electroforming device for manufacturing fine metal tubular material characterized in that:
a conductive wire core used as an electroplated material is linked to negative of power, electrolytic metal or an electrolytic metal collection net is linked to positive of power, said electrolytic metal or electrolytic metal collection net and said wire core are fully immersed in electrolyte in an electrolytic bath, after power is turned on, said wire core rotates and said electrolytic metal will build up on a surface of said wire core;
in said electrolytic bath, said electrolytic metal or electrolytic metal collection net and wire core are disposed in opposite parallel, a wire core is placed on a top of said electrolytic bath and said electrolyte will flow through a passage.

2. The electroforming device for manufacturing fine metal tubular material of claim 1, wherein said wire core and passage are communicated at a lower part, said electrolytic metal or electrolytic metal collection net and electrolytic metal collection compartment are limed at a lower part for supplying electrolyte, an electrolyte storage will provide said electrolyte flowing to said electrolytic metal collection compartment and said passage to constitute a complete electrolytic bath.
